(19) United States
(12) Patent Application Publication
(10) Pub. No.: US 2026/0200239 A1
(43) Pub. Date: Jul. 16, 2026

(54) PRINTING APPARATUS AND TEST PATTERN PRINTING METHOD

(71) Applicant: SEIKO EPSON CORPORATION, Tokyo (JP)

(72) Inventor: Takayoshi KOJIMA, AZUMINO-SHI (JP)

(21) Appl. No.: 19/444,347

(22) Filed: Jan. 9, 2026

(30) Foreign Application Priority Data
Jan. 10, 2025 (JP) 2025-003888

(51) Int. Cl. B41J 2/21

(52) U.S. Cl. CPC B41J 2/2135

(57) ABSTRACT

A printing apparatus includes a conveyance unit that conveys a medium in a conveyance direction, a print head configured to eject an ink onto the medium, and a control unit that controls printing of a test pattern for determining a maximum amount of the ink to be ejected from the print head to the medium per unit area, wherein the test pattern has a continuous area in which the ink is continuous at a set recording density, around which the ink is not ejected, with a length in a width direction intersecting the conveyance direction as a width, a width of an end portion of the continuous area, which is most downstream or most upstream in the conveyance direction, is narrower than a maximum width of the continuous area, and the control unit performs control on at least the print head to print the test pattern having the continuous area.

The present application is based on, and claims priority from JP Application Serial Number 2025-003888, filed January 10, 2025, the disclosure of which is hereby incorporated by reference herein in its entirety.

### BACKGROUND

### Technical Field

The present disclosure relates to a printing apparatus that prints a test pattern for determining a maximum amount of ink ejected from a print head per unit area of a medium and a test pattern printing method.

### Related Art

As a printing apparatus, a transfer system that transfers an image to a transfer target medium by a DTF (Direct to Film) method is known. For example, the transfer system prints an image and a white base ink layer on a transfer medium by an inkjet method, applies a powdery hot-melt adhesive to the base ink layer in a wet state by an adhesive application unit such as a shaker device, and transfers the image to a transfer target medium by a thermal transfer device. When the amount of the ink applied to the transfer medium is too large, the ink having fluidity flows to the periphery on the transfer medium, and the image quality deteriorates. Therefore, the maximum amount of the ink applied to the transfer medium is set, and the ink is used within the range of the maximum amount.

JP-A-2017-42928 discloses that an adjustment pattern including a plurality of patches in various amounts of ink per unit area of a recording medium is formed on the recording medium in order to confirm bleeding between inks having different color materials on the recording medium. The adjustment pattern includes a plurality of two-color patches in amounts of ink that change as a plurality of combinations in which patches of different colors are in contact with each other.

JP-A-2017-42928 is an example of the related art.

For example, when processing from printing of an image to application of the powdery hot-melt adhesive is performed on an elongated transfer medium in a roll-to-roll process, the transfer medium ejected from the printing apparatus descends, that is, is inclined in the conveyance direction and enters the adhesive application unit. When the amount of ink applied to the transfer medium is too large, the liquid ink drips in the conveyance direction on the inclined transfer medium, and the image quality deteriorates. Even when the above-described adjustment pattern is formed on a recording medium, it is not easy to confirm the possibility that the ink on the recording medium may drip due to the inclination of the recording medium in the conveyance direction.

The above-described problem is not limited to a printing apparatus for DTF, and can also be present in a printing apparatus that forms an image on a medium not used for DTF such as paper.

### SUMMARY

According to an aspect of the present disclosure, there is provided a printing apparatus including a conveyance unit that conveys a medium in a conveyance direction, a print head configured to eject an ink onto the medium, and a control unit that controls printing of a test pattern for determining a maximum amount of the ink to be ejected from the print head to the medium per unit area, wherein the test pattern has a continuous area in which the ink is continuous at a set recording density, around which the ink is not ejected, with a length in a width direction intersecting the conveyance direction as a width, a width of an end portion of the continuous area, which is most downstream or most upstream in the conveyance direction, is narrower than a maximum width of the continuous area, and the control unit performs control on at least the print head to print the test pattern having the continuous area.

Further, according to an aspect of the present disclosure, there is provided a test pattern printing method, in a printing apparatus including a conveyance unit that conveys a medium in a conveyance direction and a print head configured to eject an ink onto the medium, of printing a test pattern for determining a maximum amount of the ink to be ejected from the print head to the medium per unit area, the test pattern having a continuous area in which the ink is continuous at a set recording density, around which the ink is not ejected, with a length in a width direction intersecting the conveyance direction as a width, a width of an end portion of the continuous area, which is most downstream or most upstream in the conveyance direction, being narrower than a maximum width of the continuous area, the test pattern printing method including a printing step of printing the test pattern having the continuous area by ejecting the ink on medium from the print head, and a conveying step of conveying the medium having the test pattern in the conveyance direction by the conveyance unit.

### BRIEF DESCRIPTION OF THE DRAWINGS

FIG. 1 schematically shows a configuration example of a printing apparatus.

FIG. 2 is a plan view schematically showing a configuration example of a printer.

FIG. 3 is a bottom view schematically showing an example of a nozzle surface of a print head.

FIG. 4 is a block diagram schematically showing a configuration example of the printing apparatus.

FIG. 5 schematically shows an example of a printing method on a transfer target medium.

FIG. 6 schematically shows an example of a transfer medium having a single-layer test pattern.

FIG. 7 schematically shows an example of a continuous area contained in the single-layer test pattern.

FIG. 8 schematically shows an example of a transfer medium having a double-layer test pattern.

FIG. 9 schematically shows an example of a continuous area contained in the double-layer test pattern.

FIG. 10 schematically shows an example in which an ink in the continuous area flows when the transfer medium is inclined in a conveyance direction.

FIG. 11 is a flowchart schematically showing an example of maximum ink ejection amount setting processing.

FIG. 12 schematically shows a modification of the continuous area.

FIG. 13 schematically shows a modification of the continuous area.

FIG. 14 schematically shows a modification of the continuous area.

FIG. 15 schematically shows a modification of the continuous area.

### DESCRIPTION OF EMBODIMENTS

An embodiment of the present disclosure will be described below. Obviously, the following embodiment is nothing more than exemplifying the present disclosure, and all the features shown in the embodiment are not necessarily essential to the solution disclosed herein.

### Overview of Configurations in Present Disclosure

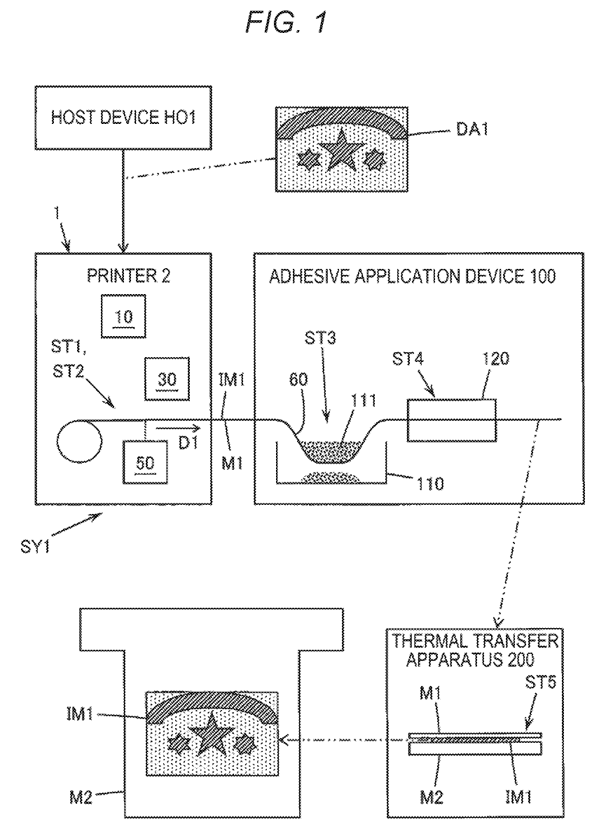

An overview of configurations in the present disclosure will first be described with reference to examples shown in FIGS. 1 to 15. Note that the drawings of the present application are diagrams schematically illustrating the examples, and in order to make each portion of these drawings have a recognizable size, the scale of each portion may be different from the actual scale, the enlargement factor may be different amount the directions illustrated in these drawings, and the drawings may not be consistent with one another. Obviously, the respective elements in the present configurations are not limited to specific examples denoted by signs. In "Overview of Configurations in Present Disclosure", a term in parentheses refers a supplementary description of a term immediately before the parentheses.

In the present application, the numerical range "from Min to Max" refers numerals equal to or larger than a minimum value Min and equal to or smaller than a maximum value Max.

### Configuration 1

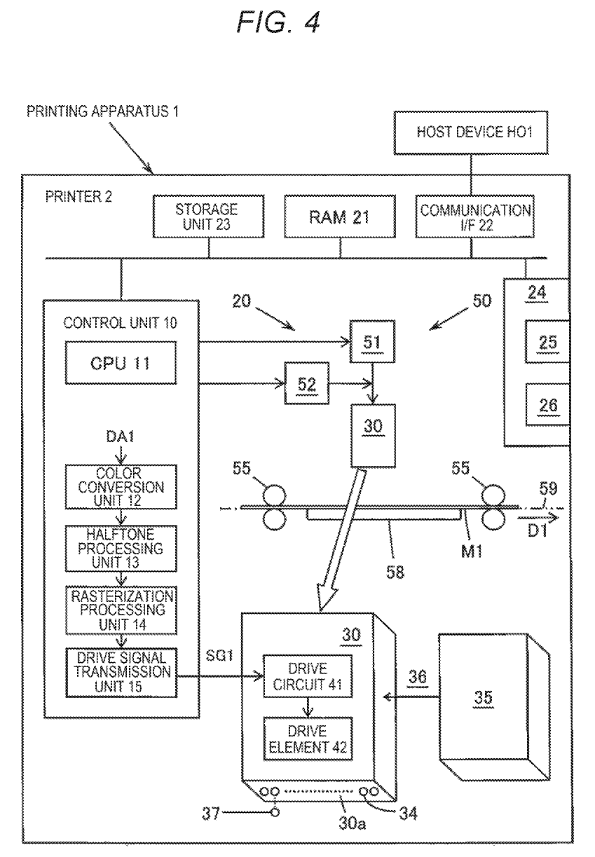

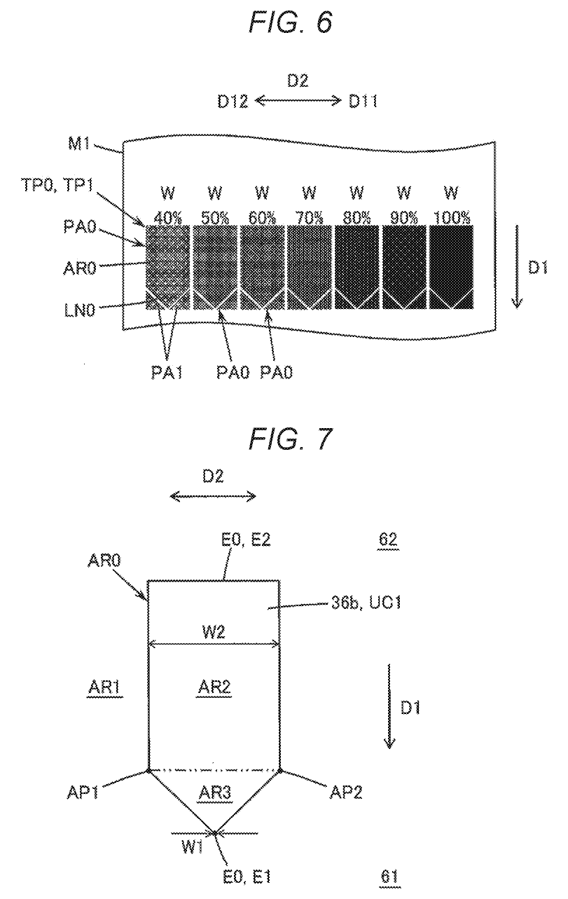

As illustrated in FIGS. 1, 4 and the like, a printing apparatus 1 according to an aspect includes a conveyance unit 55, a print head 30, and a control unit 10. The conveyance unit 55 conveys a medium (for example, a transfer medium M1) in a conveyance direction D1. The print head 30 can eject an ink 36 to the medium (M1). The control unit 10 controls printing of a test pattern TP0 (see FIGS. 6 to 9 and the like) for determining the maximum amount of the ink 36 ejected from the print head 30 to the medium (M1) per unit area. Here, the test pattern TP0 has a continuous area AR0 in which the ink 36 is continuous at a set recording density and around which the ink 36 is not ejected. Further, with a length in a width direction D2 intersecting the conveyance direction D1 as a width, a width W1 of an end portion E0 most downstream 61 or most upstream 62 in the conveyance direction D1 in the continuous area AR0 is narrower than a maximum width W2 of the continuous area AR0. The control unit 10 performs control on at least the print head 30 to print the test pattern TP0 having the continuous area AR0.

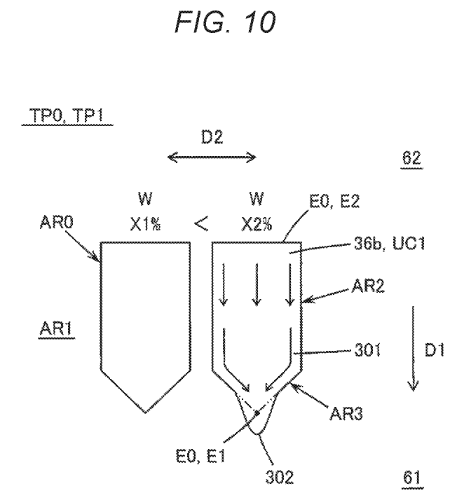

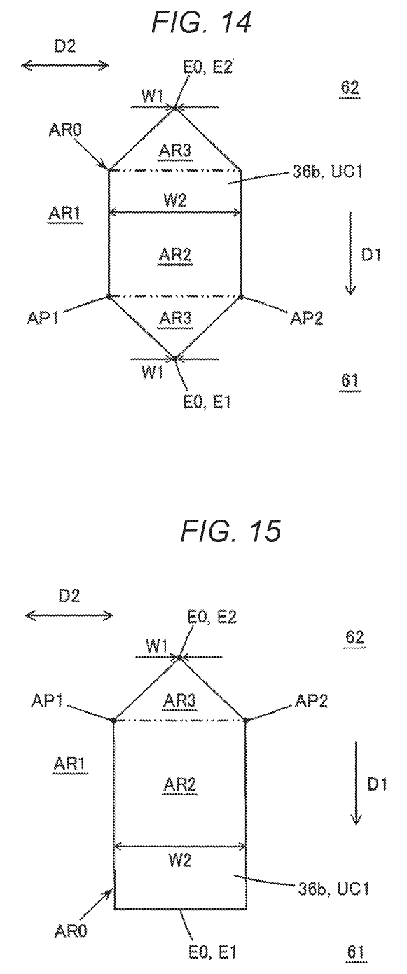

In a case where fluidity remains in the ink 36 landed on the medium (M1), when the medium (M1) ejected from the printing apparatus 1 in the conveyance direction D1 is inclined in the conveyance direction D1, for example, when hanging down, the ink 36 on the medium (M1) may drip along the conveyance direction D1. The dripping of the ink 36 may refer to overflowing and flowing out of the ink 36 from the landing range. For example, when the medium (M1) ejected from the printing apparatus 1 hangs down, the ink 36 on the medium (M1) may drip in the conveyance direction D1, and when the medium (M1) moves upward, the ink 36 on the medium (M1) may drip in a direction opposite to the conveyance direction D1. Here, in the continuous area AR0 contained in the test pattern TP0, the end portion E0 located most downstream 61 in the conveyance direction D1 is referred to as a "most downstream portion E1", and in the continuous area AR0, the end portion E0 located most upstream 62 in the conveyance direction D1 is referred to as a "most upstream portion E2". As illustrated in FIG. 10, in a case where the width of the most downstream portion E1 is narrower than the maximum width W2 of the continuous area AR0, when the medium (M1) is inclined such that the most downstream portion E1 is lower than the most upstream portion E2, the ink 36 flowing in the continuous area AR0 accumulates in the narrower most downstream portion E1, and thus easily drips from the most downstream portion E1. Accordingly, it is possible to easily confirm the possibility that the ink 36 drips due to the inclination of the medium (M1) such that the most downstream portion E1 is lower than the most upstream portion E2. Further, as illustrated in FIGS. 14 and 15, in a case where the width of the most upstream portion E2 is narrower than the maximum width W2 of the continuous area AR0, when the medium (M1) is inclined such that the most upstream portion E2 is lower than the most downstream portion E1, the ink 36 flowing in the continuous area AR0 accumulates in the narrower most upstream portion E2, and thus easily drips from the most upstream portion E2. Accordingly, it is possible to easily confirm the possibility that the ink 36 drips due to the inclination of the medium (M1) such that the most upstream portion E2 is lower than the most downstream portion E1. Therefore, according to the configuration, it is possible to provide an apparatus that prints a test pattern in which it is possible to easily confirm the possibility that the ink on the medium drips when confirming the maximum amount of the ink ejected from the print head to the medium per unit area. Since the continuous area has a shape in which the ink easily drips, when the ink does not drip in the continuous area, the ink may be harder to drip during printing other than the test pattern.

The "maximum amount of ink ejected from the print head to the medium per unit area" is also referred to as a "maximum ink ejection amount".

Various examples are conceivable in the configuration described above.

The medium may be a transfer medium for transferring an image to a transfer target medium, or may be a medium that is not used for transfer, such as paper.

The number of types of ink present in the continuous area may be one, two, or more.

The recording density in the continuous area may be constant or may vary. The recording density (referred to as RD) means a ratio (including a percentage) of the number of dots formed by droplets with respect to a predetermined number of pixels, and means a ratio when converted to the largest dot (for example, a large dot) when dots having different sizes are formed. The pixel is the minimum element that forms an image, to which a color is individually assigned. For example, when Nd large dots are formed for 100 pixels, the record density RD is Nd%.

When the end portion that is the "most downstream portion" or the "most upstream portion" is regarded as a point, the width of the end portion is close to zero and is narrower than the maximum width of the continuous area.

In the continuous area, when the width of the most downstream portion is narrower than the maximum width of the continuous area as illustrated in FIG. 7, the width of the most upstream portion may be the maximum width of the continuous area. In the continuous area, when the width of the most upstream portion is narrower than the maximum width of the continuous area as illustrated in FIG. 15, the width of the most downstream portion may be the maximum width of the continuous area.

The control unit may control at least the print head, and may also control the conveyance unit when the printing apparatus is a serial printer or the like.

Obviously, the additional remarks described above also apply to the following configurations.

### Configuration 2

As illustrated in FIGS. 7 and 15 and the like, the continuous area AR0 may include a main body portion AR2 having a width equal to the maximum width W2 of the continuous area AR0 and a transition portion AR3 extending from the main body portion AR2 toward the end portion E0. The transition portion AR3 may be tapered from the main body portion AR2 toward the end portion E0.

In the above case, the ink 36 flowing in the continuous area AR0 is guided to the tapered transition portion AR3 and easily accumulate in the end portion E0, and thus the ink 36 more easily drips from the end portion E0 in the continuous area AR0. Therefore, according to the above configuration, it is possible to provide an apparatus that prints a test pattern in which the possibility that the ink on the medium drips can be more easily confirmed.

### Configuration 3

As illustrated in FIGS. 7, 15, and the like, the transition portion AR3 including the end portion E0 may have a triangular shape, and the end portion E0 may be located at a vertex of the triangular shape.

IN THIS CASE, SINCE THE END PORTION E0 OF THE CONTINUOUS AREA AR0 IS POINTED, THE INK 36 MORE EASILY DRIPS FROM THE END PORTION E0 IN THE CONTINUOUS AREA AR0. THEREFORE, ACCORDING TO THE CONFIGURATION, IT IS POSSIBLE TO PROVIDE AN APPARATUS THAT PRINTS A TEST PATTERN IN WHICH THE POSSIBILITY THAT THE INK ON THE MEDIUM DRIPS CAN BE MORE EASILY CONFIRMED.

Configuration 4

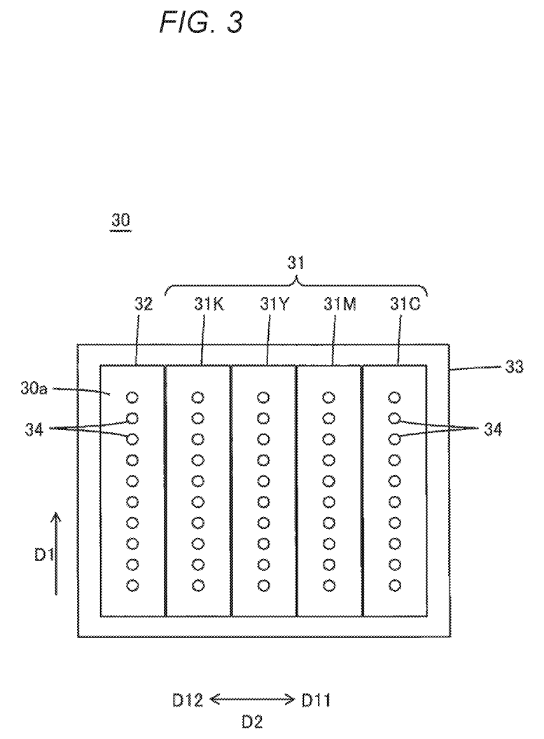

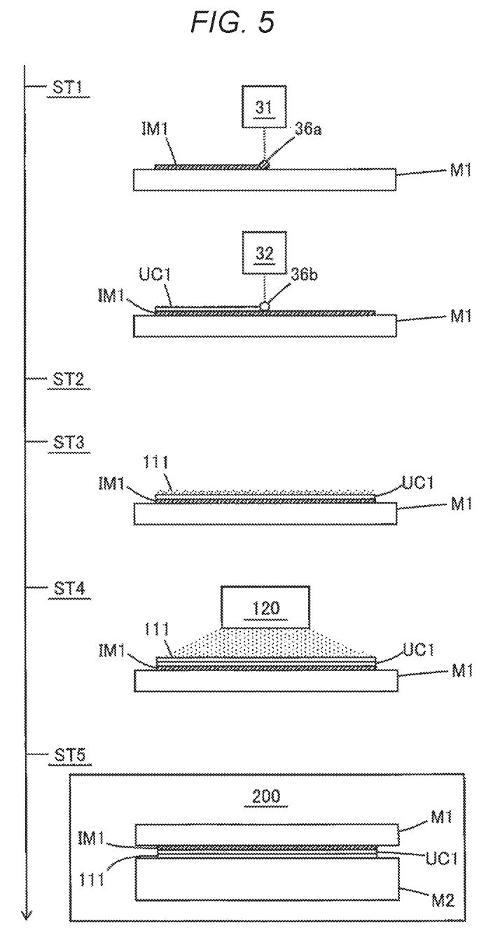

As illustrated in FIGS. 3 and 5, the print head 30 may be capable of ejecting, as the ink 36, an image forming ink (for example, a colored ink 36a) for forming an image IM1 and a base ink 36b for forming a base ink layer UC1 to the medium (M1). As illustrated in FIGS. 7, 9, and the like, the control unit 10 may perform control on at least the print head 30 to print the continuous area AR0 in which at least the base ink 36b is present.

When the image IM1 and the base ink layer UC1 are overlapped, the base ink 36b is often used more than the image forming ink (36a). The base ink 36b used more is present in the continuous area AR0, and thus it is possible to more easily confirm the possibility that the ink 36 on the medium drips.

Here, the base ink may be an ink other than the image forming ink, or may be an ink used also as the image forming ink. Examples of the base ink include white ink, black ink, gray ink, and clear ink having no coloring material.

The ink present in the continuous area may be only the base ink, or may include both the base ink and the image forming ink.

The additional remarks described above also apply to the following configurations.

### Configuration 5

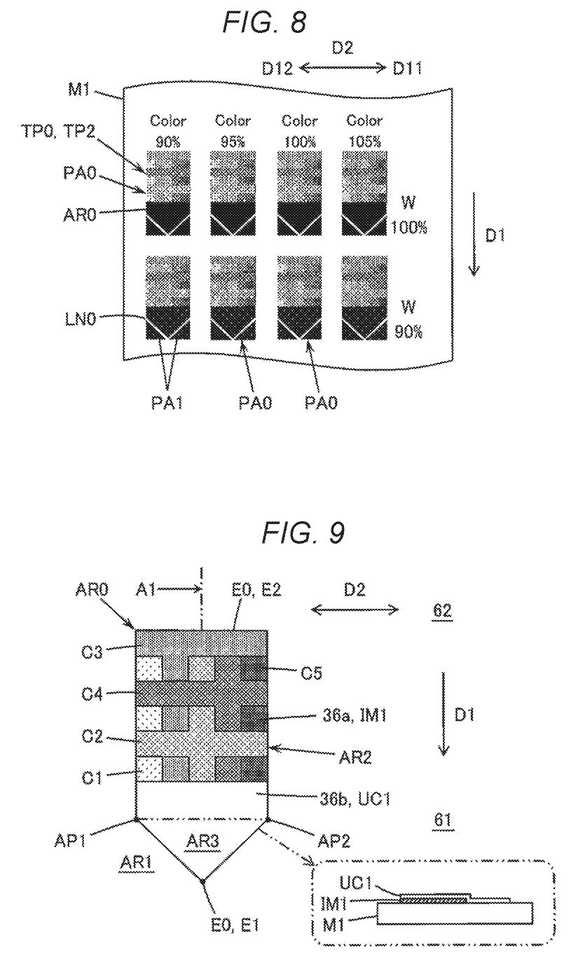

As illustrated in FIGS. 8 and 9, both the image forming ink (36a) and the base ink 36b may be present in the continuous area AR0. The control unit 10 may perform control on at least the print head 30 to print the continuous area AR0 in which the ink 36 including both the image forming ink (36a) and the base ink 36b is continuous.

In this case, since both the image forming ink (36a) and the base ink 36b are present in the continuous area AR0, it is possible to more easily confirm the possibility that the ink on the medium drips.

### Configuration 6

As illustrated in FIGS. 6 and 8, the test pattern TP0 may include the plurality of continuous areas AR0 having different recording densities. The control unit 10 may perform control on at least the print head 30 to print the test pattern TP0 having the plurality of continuous areas AR0.

In this case, since the plurality of continuous areas AR0 having different recording densities are present in the test pattern TP0, it is possible to provide an apparatus that prints a test pattern in which the maximum ink ejection amount can be determined in consideration of the possibility that the ink on the medium drips.

### Configuration 7

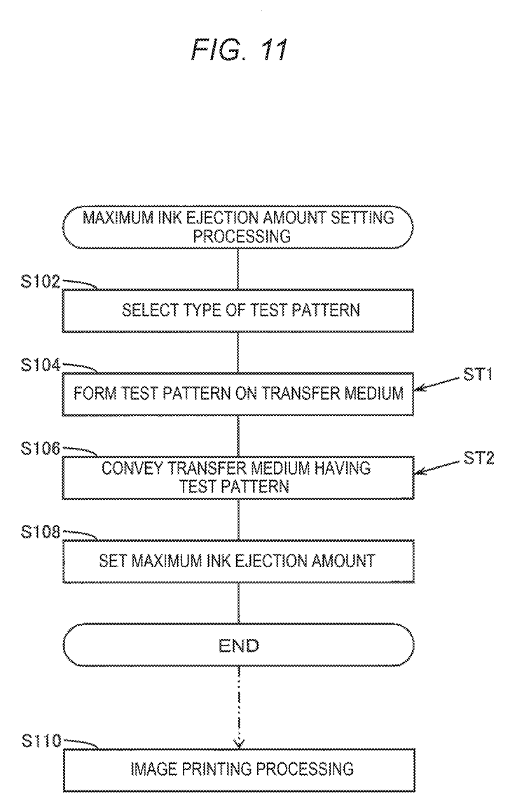

A test pattern printing method according to an aspect is a test pattern printing method for printing the test pattern TP0 in the printing apparatus 1 including the conveyance unit 55 and the print head 30, and, as illustrated in FIG. 11, includes the following steps:

(a1) a printing step ST1 of printing the test pattern TP0 having the continuous area AR0 by ejecting the ink 36 from the print head 30 to the medium (M1); and

(a2) a conveying step ST2 of conveying the medium (M1) having the test pattern TP0 in the conveyance direction D1 by the conveyance unit 55.

According to the configuration, it is possible to provide a method of printing a test pattern in which it is possible to easily confirm the possibility that the ink on the medium drips when confirming the maximum amount of the ink ejected from the print head to the medium per unit area.

Further, the configurations described above can be applied to a printing system including the printing apparatus described above, a control method for the printing apparatus described above, a control program for the printing apparatus described above, a control method for the printing system described above, a control program for the printing system described above, a non-transitory computer-readable medium recording any one of the control programs described above, and the like. In addition, the printing apparatus described above may be configured with a plurality of distributed portions.

### Specific Example of Printing Apparatus

FIG. 1 schematically illustrates the configuration of a printing system SY1 that forms the image IM1 on the transfer medium M1 continuous in the conveyance direction D1 and transfers the image IM1 to a transfer target medium M2. The printing system SY1 includes at least the printing apparatus 1, and may include an adhesive application device 100 and a thermal transfer device 200.

The printing apparatus 1 may be a single printer 2 or may include the printer 2 and a host device HO1. The host device HO1 illustrated in FIG. 1 can generate image data DA1 corresponding to the image IM1 to be transferred and transmit the image data DA1 to the printer 2. Hereinafter, the image IM1 to be transferred is also referred to as the transferred image IM1. The printer 2 includes the print head 30, a drive unit 50, and the control unit 10, and forms the image IM1 corresponding to the image data DA1 on the elongated transfer medium M1. The transfer medium M1 is set in the printer 2 in a unrollable rolled state, for example. The adhesive application device 100 includes a shaker unit 110 that applies a powdery adhesive 111 to the ink of the transfer medium M1, and a heating unit 120 that heats the transfer medium M1 with the adhesive applied thereto. The shaker unit 110 is an example of an adhesive application unit that applies the adhesive 111 to the transfer medium M1 having a base ink layer. The processing from the printing of the image IM1 to the application of the adhesive 111 to the transfer medium M1 is performed in a roll-to-roll process. The adhesive application device 100 may include a roll-up unit that rolls up the transfer medium M1 after the heat treatment. The thermal transfer device 200 transfers the image IM1 from the transfer medium M1 to the transfer target medium M2.

As the transfer medium M1, a transfer film or the like capable of transferring an image by a DTF (Direct to Film) method can be used. As such a transfer film, a film that hardly absorbs the ink 36 including a resin film such as a PET (polyethylene terephthalate) film can be suitably used. Obviously, the material of the transfer medium M1 may include paper, metal, or the like other than resin, and the transfer medium M1 may be a metal film or the like. As the adhesive 111, a powdery adhesive such as a powdery hot-melt adhesive can be used. The hot-melt adhesive is a thermoplastic resin powder, and melts when heated to a melting point or higher, and solidifies when cooled. As the hot-melt adhesive, an adhesive containing one or more thermoplastic resins selected from a polyurethane resin, a polyolefin resin, a polyamide resin, a polyester resin, and the like can be used. As the transfer target medium M2, a fabric such as a knitted fabric or a woven fabric, a nonwoven fabric, or the like can be used, and a fabric processed like a T-shirt or the like may be used.

Although the details will be described later, the printing step ST1 and the conveying step ST2 are performed in the printing apparatus 1. In the adhesive application device 100, an adhesive application step ST3 and a heating step ST4 are performed. In the thermal transfer device 200, a transfer step ST5 is performed.

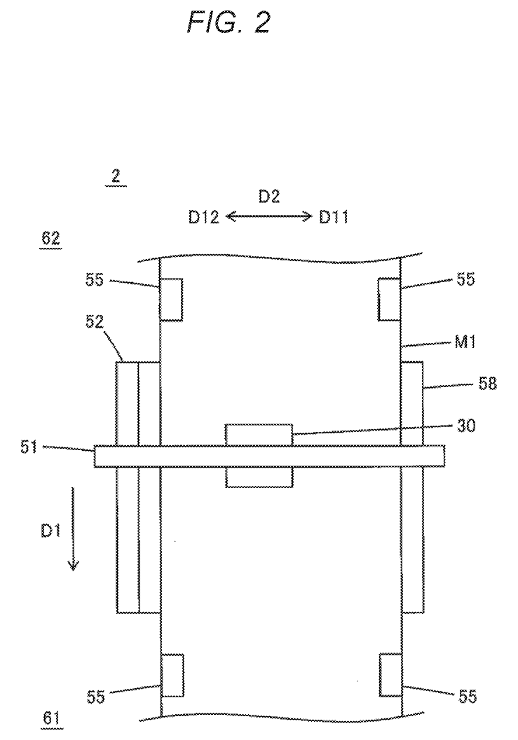

FIG. 2 is a plan view schematically illustrating the configuration of the printer 2 including the print head 30. In FIG. 2, the conveyance direction D1 is a downward direction, and the transfer medium M1 is conveyed from upstream 62 toward downstream 61. FIG. 3 is a bottom view schematically illustrating a nozzle surface 30a of the print head 30. FIG. 4 is a block diagram schematically illustrating the configuration of the printing apparatus 1. FIG. 5 schematically illustrates a printing method on the transfer target medium M2.

The print head 30 illustrated in FIGS. 2 to 4 is an inkjet head capable of ejecting a plurality of types of inks 36, and the printer 2 is an inkjet printer that ejects ink droplets 37 in a liquid state. The printer 2 includes the control unit 10, a printing unit 20, a RAM (Random Access Memory) 21 that is a semiconductor memory, a communication I/F (interface) 22, a storage unit 23, and an operation panel 24. The control unit 10, the RAM 21, the communication I/F 22, the storage unit 23, and the operation panel 24 are coupled to a bus and can input and output information to and from one another. The printing unit 20 includes the print head 30 and the drive unit 50.

The control unit 10 includes a CPU (Central Processing Unit) 11 that is a processor, a color conversion unit 12, a halftone processing unit 13, a rasterization processing unit 14, a drive signal transmission unit 15, and the like. The control unit 10 can be configured with an SoC (System on a Chip) or the like. The control unit 10 controls the print head 30 and the drive unit 50 to form the image IM1 of the colored ink 36a and the base ink layer UC1 (see FIGS. 5 and 9) to which the adhesive 111 is applied on the transfer medium M1 based on the image data DA1 acquired from one of the host device HO1, an external memory (not illustrated), and the like. The colored ink 36a is an example of the image forming ink for forming the image IM1 to be transferred to the transfer target medium M2. For example, RGB data having, for example, integer values at 2⁸ gray levels of R (red), G (green), and B (blue) for the respective pixels can be applied to the image data DA1.

The CPU 11 is a device that mainly performs information processing and control in the printer 2.

The color conversion unit 12 includes, for example, a color conversion LUT (lookup table) in which a correspondence relationship between gray level values of R, G, and B and gray level values of C (cyan), M (magenta), Y (yellow), K (black), and W (white) is defined. In the color conversion LUT, the gray level value of W is, for example, a value at which the base ink 36b is used when the colored ink 36a of at least one of C, M, Y, and K is used. The base ink 36b is an ink for forming the base ink layer UC1, and is a W ink in this specific example. As an example of the color conversion LUT, the gray level value of W may be 0 indicating that the base ink is not used when the gray level values of C, M, Y, and K are 0 indicating that the colored ink is not used, and the gray level value of W may be 128 indicating that the base ink is used at 50% in the other cases. As a result, the base ink 36b is superimposed on the position of the image IM1. Obviously, the ejection amount of the base ink 36b superimposed on the image IM1 may be less than 50%, or more than 50% in a range in which the transferred image IM1 having good image quality is obtained. The color conversion unit 12 converts the RGB data into ink amount data having, for example, integer values at 2⁸ gray levels of C, M, Y, K, and W for the respective pixels with reference to the color conversion LUT. The ink amount data represents the usage amount of the ink 36 of C, M, Y, K, and W in units of pixels. The ink 36 illustrated in FIG. 4 includes the colored inks 36a of C, M, Y, and K and the base ink 36b. When the resolution of the RGB data is different from the print resolution, the color conversion unit 12 first converts the resolution of the RGB data into the print resolution or converts the resolution of the ink amount data into the print resolution.

The halftone processing unit 13 generates dot data in which the number of gray levels is reduced to, for example, 2 or 4 by performing halftone processing on the ink amount data by one of a dither method, an error diffusion method, and the like. The dot data is generated for each of C, M, Y, K, and W. The dot data represents the dot formation state of the ink 36 in units of pixels. The dot data may be binary data representing the presence or absence of dot formation, or may be multi-valued data at three or more gray levels that can support dots having different sizes such as small, medium, and large dots.

The rasterization processing unit 14 generates raster data by performing rasterization processing of rearranging dot data for each of C, M, Y, K, and W in the order in which dots are formed by the drive unit 50.

The drive signal transmission unit 15 generates a drive signal SG1 corresponding to the voltage signal applied to a drive element 42 of the print head 30 from the raster data and outputs the signal to a drive circuit 41 of the print head 30. For example, when the raster data is "forming large dots", the drive signal transmission unit 15 outputs the drive signal SG1 for ejecting the ink droplets for large dots, and when the raster data is "forming small dots", outputs the drive signal SG1 for ejecting the ink droplets for small dots.

The RAM 21 stores the image data DA1 and the like received from the host device HO1 and the like. The communication I/F 22 inputs and outputs information to and from the host device HO1 and the like. Examples of the host device HO1 include a computer such as a personal computer or a tablet terminal, and a mobile phone such as a smartphone. The storage unit 23 may be a nonvolatile semiconductor memory such as a flash memory, or may be a magnetic storage device such as a hard disk, or the like. The operation panel 24 includes an output unit 25 such as a liquid crystal panel that displays information, an input unit 26 such as a touch panel that receives an operation on a display screen, and the like.

The drive circuit 41 applies a voltage signal to the drive element 42 in accordance with the drive signal SG1 input from the drive signal transmission unit 15. The drive element 42 may be a piezoelectric element that applies pressure to the ink 36 within a pressure chamber communicating with a nozzle 34, a drive element that generates air bubbles in the pressure chamber with heat to eject the ink droplets 37 from the nozzle 34, or the like. The ink 36 is supplied to the pressure chamber of the head 30 from an ink cartridge 35. The ink 36 within the pressure chamber is ejected by the drive element 42 as the ink droplets 37 from the nozzle 34 toward the transfer medium M1. When the ink droplets 37 land on the transfer medium M1, dots are formed on the transfer medium M1. When the dots of the colored ink 36a are formed on the transfer medium M1, the image IM1 represented by a dot pattern is formed on the transfer medium M1.

The print head 30 illustrated in FIG. 3 includes a colored ink head 31 that ejects the colored inks 36a and a base ink head 32 that ejects the base ink 36b. The colored ink heads 31 include a C ink head 31C that ejects the C ink, an M ink head 31M that ejects the M ink, a Y ink head 31Y that ejects the Y ink, and a K ink head 31K that ejects the K ink. Each of the ink heads (31C, 31M, 31Y, 31K, and 32) has a nozzle row in which a plurality of nozzles 34 are arranged in a nozzle arrangement direction. The nozzle arrangement direction illustrated in FIG. 3 is the conveyance direction D1, but the nozzle arrangement direction may be a direction different from the conveyance direction D1. The plurality of nozzles 34 of each ink head may be arranged in a staggered manner in the nozzle arrangement direction, in other words, in two rows in the nozzle arrangement direction. Each nozzle 34 of the colored ink head 31 ejects the colored ink 36a as the ink droplet 37, and each nozzle 34 of the base ink head 32 ejects the base ink 36b as the ink droplet 37. The print head 30 illustrated in FIGS. 2 to 4 is mounted on a carriage 33 movable along the width direction D2 as a main scanning direction. The main scanning direction may be a direction different from the width direction D2. When the printer 2 performs lateral printing, the carriage 33 illustrated in FIG. 3 can also move along the conveyance direction D1 as a sub-scanning direction.

The drive unit 50 of the lateral type includes a main scanning drive unit 51, a sub-scanning drive unit 52, and the conveyance unit 55, and changes the relative positional relationship between the print head 30 and the transfer medium M1. The main scanning drive unit 51 illustrated in FIG. 2 performs main scanning in which the ink 36 is ejected from the print head 30 in at least one of a forward direction D11 and a backward direction D12 while moving the print head 30 along the width direction D2 as the main scanning direction. The sub-scanning drive unit 52 illustrated in FIG. 2 performs sub-scanning in which the print head 30 is moved along the conveyance direction D1 as the sub-scanning direction during the main scanning. That is, the print head 30 intermittently moves along the conveyance direction D1 during the sub-scanning. The conveyance unit 55 conveys the transfer medium M1 in the conveyance direction D1 from the position facing the print head 30 toward the shaker unit 110 during printing. That is, the transfer medium M1 intermittently moves along the conveyance direction D1 during non-printing. The conveyance unit 55 illustrated in FIGS. 2 and 4 sends the transfer medium M1 in the conveyance direction D1 along a conveyance path 59. A platen 58 is located under the conveyance path 59 and supports the transfer medium M1 in contact with the transfer medium M1 in the conveyance path 59. The print head 30 controlled by the control unit 10 causes the ink 36 to adhere to the transfer medium M1 by ejecting the ink droplets 37 toward the transfer medium M1 supported by the platen 58.

The control unit 10 controls the ejection of the colored inks 36a from the colored ink head 31, the ejection of the base ink 36b from the base ink head 32, and the drive unit 50.

The base ink head 32 may be variously disposed as long as the base ink 36b can be superimposed on the image IM1 formed by the colored inks 36a. For example, the base ink head 32 may be disposed at a position toward the forward direction D11 from the C ink head 31C illustrated in FIG. 3, or may be disposed at a position toward a direction opposite to the sub-scanning direction from the colored ink head 31.

Next, the printing method on the transfer target medium M2 will be described with reference to FIG. 5. The printing method shown in FIG. 5 includes the following steps:

(c1) a printing step ST1 of forming the image IM1 on the transfer medium M1 by ejecting the colored inks 36a from the print head 30 and forming the base ink layer UC1 on the transfer medium M1 by ejecting the base ink 36b from the print head 30;

(c2) a conveying step ST2 conveying the transfer medium M1 having the image IM1 and the base ink layer UC1 in the conveyance direction D1 by the conveyance unit 55;

(c3) an adhesive application step ST3 of applying the adhesive 111 to the transfer medium M1 having the image IM1 and the base ink layer UC1;

(c4) a heating step ST4 of heating the transfer medium M1 to which the adhesive 111 is applied; and

(c5) a transfer step ST5 of transferring the image IM1 to the transfer target medium M2 by applying the adhesive 111 to the transfer target medium M2.

In the printing step ST1, the base ink layer UC1 is superimposed on the image IM1 on the transfer medium M1.

In the example illustrated in FIG. 1, in the conveying step ST2, the transfer medium M1 having the base ink layer UC1 together with the image IM1 is intermittently conveyed from the printer 2 to the adhesive application device 100, and enters the shaker unit 110 via a descending portion 60 that is inclined downward. The shaker unit 110 applies the powdery adhesive 111 to the base ink layer UC1 that is not dried yet. The shaker unit 110 is an example of the adhesive application unit that applies the adhesive 111 to the transfer medium M1 having the base ink layer UC1. When the transfer medium M1 ejected from the printer 2 hangs down, the ink 36 on the transfer medium M1 may drip along the conveyance direction D1. A test pattern TP0 (see FIGS. 6 and 8) for preventing dripping of the ink 36 will be described later.

FIG. 5 illustrates a state in which the image IM1, the base ink layer UC1, and the powdery adhesive 111 are stacked on the transfer medium M1 in the adhesive application step ST3. In the example illustrated in FIG. 1, the transfer medium M1 to which the thermoplastic adhesive 111 is applied is intermittently conveyed from the shaker unit 110 to the heating unit 120. During the period, the excessive adhesive 111 is shaken off by the transfer medium M1 inclined again or otherwise. The heating unit 120 heats the transfer medium M1 with the adhesive 111 applied thereto. When the transfer medium M1 is heated to a temperature equal to or higher than the temperature at which the adhesive 111 melts, the adhesive 111 melts. FIG. 5 illustrates a state in which the image IM1, the dried base ink layer UC1, and the melted adhesive 111 are sequentially stacked on the transfer medium M1 in the heating step ST4. When the thermal transfer device 200 is capable of heating the transfer medium M1, the heating unit 120 may perform preheating for heating the transfer medium M1 to a temperature lower than the melting temperature of the adhesive 111. In the example illustrated in FIG. 1, the heated transfer medium M1 is intermittently ejected from the heating unit 120. The ejected transfer medium M1 is cut as necessary, superimposed on the transfer target medium M2 with the surface with the adhesive 111 applied thereto facing the transfer target medium M2, and conveyed into the thermal transfer device 200.

The thermal transfer device 200 pressurizes the transfer medium M1 and the transfer target medium M2 with the adhesive 111 applied to the transfer medium M1 in contact with the transfer target medium M2. By pressing the transfer medium M1 and the transfer target medium M2, the image IM1 is attached to the transfer target medium M2 via the base ink layer UC1 and the adhesive 111. In this way, the transfer step ST5 of transferring the image IM1 to the transfer target medium M2 is performed. When the transfer medium M1 is separated from the transfer target medium M2, the image IM1 remains on the transfer target medium M2, and as shown in FIG. 1, the transfer target medium M2 to which the image IM1 is transferred is obtained.

If the amount of the ink 36 applied to the transfer medium M1 is too large, when the transfer medium M1 ejected from the printer 2 is inclined in the conveyance direction D1, the liquid ink 36 may drip in the conveyance direction D1 on the transfer medium M1. In particular, since the transfer medium M1 hardly absorbs the ink 36, the ink 36 on the transfer medium M1 tends to drip easily. When the dripping of the ink 36 occurs, the quality of the image IM1 transferred to the transfer target medium M2 deteriorates. In this specific example, the test pattern TP0 (see FIGS. 6 and 8) for determining the maximum ink ejection amount is formed on the transfer medium M1 in consideration of dripping of the ink 36 due to the inclination of the transfer medium M1 in the conveyance direction D1.

FIG. 6 schematically illustrates the transfer medium M1 having a single-layer test pattern TP1 as the test pattern TP0. For convenience of illustration, the W ink landed on the transfer medium M1 is shown in black. FIG. 7 schematically illustrates the continuous area AR0 contained in the single-layer test pattern TP1. The continuous area AR0 may be an inspection area for confirming the possibility that the ink 36 on the transfer medium M1 drips.

In this specific example, the base ink 36b as the W ink is the ink used in the largest amount among the plurality of types of inks 36. The single-layer test pattern TP1 is formed of the base ink 36b in the large usage amount, and includes a plurality of patches PA0 having different recording densities. The single-layer test pattern TP1 shown in FIG. 6 includes seven patches PA0 in increments of 10% from the recording density of 40% to the recording density of 100%. The single-layer test pattern TP1 may include the plurality of patches PA0 for determining the maximum ink ejection amount, that is, the maximum amount of the ink 36 ejected from the print head 30 to the transfer medium M1 per unit area. The range of the recording density in the single-layer test pattern TP1 is not limited to 40 to 100%, and the difference in recording density between the patches PA0 is not limited to 10%. Each patch PA0 includes a pentagonal continuous area AR0 and two triangular separated areas PA1. Each separated area PA1 and the continuous area AR0 are separated by separation lines LN0 having a recording density of 0% at which the ink 36 is not ejected. The continuous area AR0 is surrounded by a non-ejection area AR1 where the ink 36 is not ejected. In each continuous area AR0, the base ink 36b is continuous at a constant recording density set at seven levels from 40 to 100%. Therefore, the single-layer test pattern TP1 may have a plurality of continuous areas AR0 having different recording densities.

Here, a length in the width direction D2 intersecting the conveyance direction D1 is defined as a width. As shown in FIG. 7, the width W1 of the most downstream portion E1 as the end portion E0 located most downstream 61 in the conveyance direction D1 in the continuous area AR0 is narrower than the maximum width W2 of the continuous area AR0. For convenience, in the continuous area AR0, a portion having the maximum width W2 is referred to as the main body portion AR2, and a portion from the main body portion AR2 toward the most downstream portion E1 is referred to as the transition portion AR3. The main body portion AR2 shown in FIG. 7 has a rectangular shape having the maximum width W2 from the most upstream portion E2 to the transition portion AR3. The transition portion AR3 including the most downstream portion E1 has an isosceles triangular shape, and the most downstream portion E1 is located at the vertex of the triangular shape described above. Therefore, the most downstream portion E1 can be regarded as a pointed point and the width W1 of the most downstream portion E1 is close to zero. FIG. 7 also shows remaining vertices AP1 and AP2 of the triangular shape described above. The transition portion AR3 may have a tapered shape from the main body portion AR2 toward the most downstream portion E1.

Since the separation lines LN0 are present in each patch PA0, the base ink 36b accumulates in the most downstream portion E1 by the surface tension of the base ink 36b when the transfer medium M1 is inclined. Note that the separation lines LN0 are present in each patch PA0 in order to confirm collapse of thin lines. For confirmation of the possibility that the ink 36 on the transfer medium M1 drips, a separated area PA1 is not necessarily provided in the patch PA0.

FIG. 8 schematically illustrates the transfer medium M1 having a double-layer test pattern TP2 as the test pattern TP0. For convenience of illustration, the W ink landed on the transfer medium M1 is indicated by black, and the colored ink 36a landed on the transfer medium M1 is indicated by shading. FIG. 9 schematically illustrates the continuous area AR0 contained in the double-layer test pattern TP2. A cross section of the transfer medium M1 at a position A1 is schematically illustrated within a two-dot chain line in FIG. 9. The continuous area AR0 of the double-layer test pattern TP2 may be an inspection area for confirming the possibility that the colored inks 36a bleed into each other in addition to the possibility that the ink 36 drips.

The double-layer test pattern TP2 is formed of both the colored ink 36a and the base ink 36b. In each continuous area AR0, both the colored ink 36a and the base ink 36b are present. As shown in FIG. 9, in each continuous area AR0, the image IM1 by the colored ink 36a is in a narrower range than that of the base ink layer UC1 by the base ink 36b. The double-layer test pattern TP2 includes a plurality of patches PA0 in which the recording density of the colored ink 36a is varied in increments of 5% in the width direction D2 and the recording density of the base ink 36b is varied in increments of 10% in the conveyance direction D1. The double-layer test pattern TP2 may also include the plurality of patches PA0 for determining the maximum ink ejection amount. The difference in the recording density of the colored ink 36a between the patches PA is not limited to 5% and the difference in the recording density of the base ink 36b between the patches PA0 is not limited to 10%. Each patch PA0 includes the pentagonal continuous area AR0 and the two triangular separated areas PA1, and each separation area PA1 and the continuous area AR0 are separated by the separation line LN0 having the recording density of 0%. The continuous area AR0 of the double-layer test pattern TP2 is also surrounded by the non-ejection area AR1 where the ink 36 is not ejected. In each continuous area AR0, the ink 36 is continuous at recording densities set in increments of 5% for the colored ink 36a and in increments of 10% for the base ink 36b. Therefore, the double-layer test pattern TP2 may have the plurality of continuous areas AR0 having different recording densities.

Also in the continuous area AR0 shown in FIG. 9, the width W1 of the most downstream portion E1 is narrower than the maximum width W2 of the continuous area AR0. The rectangular main body portion AR2 includes the image IM1 of the colored ink 36a present in the area from the most upstream portion E2 to an intermediate part toward the transition portion AR3, and the base ink layer UC1 of the base ink 36b present on the entire area. The image IM1 described above includes an area of a first color C1, an area of a second color C2, an area of a third color C3, an area of a fourth color C4, and an area of a fifth color C5. In the present application, "first", "second", and so on are terms used to identify each component element contained in the plurality of component elements similar to one another, and do not indicate the order. The above-described colors (C1 to C5) may be set by default or may be set according to input by a user. The area of each color (C1to C5) is in contact with one or more of the areas of colors different from the color. For example, the area of the first color C1 is in contact with the areas of the three colors (C2 to C4). Therefore, in the main body portion AR2, it is possible to confirm the possibility that the colored inks 36a bleed into each other. In contrast, in the transition portion AR3 having the isosceles triangular shape, only the base ink layer UC1 by the base ink 36b is present, and the image IM1 formed by the colored ink 36a is not present. Since the transition portion AR3 has the tapered shape from the main body portion AR2 toward the most downstream portion E1, it is possible to easily confirm the possibility that the ink 36 drips.

The printing apparatus 1 holds single-layer test pattern data for printing the single-layer test pattern TP1 shown in FIG. 6 and double-layer test pattern data for printing the double-layer test pattern TP2 shown in FIG. 8. The control unit 10 of the printer 2 can cause the drive unit 50 to move the print head 30 and cause the base ink head 32 to eject the base ink 36b so that the single-layer test pattern TP1 is formed on the transfer medium M1 according to the single-layer test pattern data. Further, the control unit 10 can cause the drive unit 50 to move the print head 30 and cause the print head 30 to eject the ink 36 so that the double-layer test pattern TP2 is formed on the transfer medium M1 according to the double-layer test pattern data. Both of the test pattern data may be stored in the storage unit 23 of the printer 2, or may be stored in the host device HO1 and transmitted to the printer 2.

FIG. 10 schematically illustrates, with the single-layer test pattern TP1 as an example, a state in which the ink 36 in the continuous area AR0 flows when the transfer medium M1 is inclined such that the most downstream portion E1 is lower than the most upstream portion E2. FIG. 10 shows the continuous area AR0 having a recording density of X1% and the continuous area AR0 having a recording density of X2% higher than the recording density of X1%.

When the transfer medium M1 having the single-layer test pattern TP1 moves in the conveyance direction D1 and the transfer medium M1 is inclined such that the most downstream portion E1 is lower than the most upstream portion E2, the base ink 36b having fluidity remaining in the continuous area AR0 flows in the conveyance direction D1. In FIG. 10, a flow 301 of the base ink 36b in the conveyance direction D1 is indicated by arrows in the continuous area AR0 having the recording density of X2%. When the amount of the flowing base ink 36b is larger, the base ink 36b is guided to the triangular transition portion AR3 in contact with the non-ejection area AR1 and accumulates in the narrower most downstream portion E1, so that dripping 302 occurs in the most downstream portion E1. The dripping 302 may refer to overflowing and flowing out of the base ink 36b from the continuous area AR0. Since the part around the continuous area AR0 is the non-ejection area AR1, when the transfer medium M1 is inclined, the base ink 36b accumulates in the most downstream portion E1 by the surface tension of the base ink 36b. When the width W1 of the most downstream portion E1 is the maximum width W2, the dripping 302 hardly occurs in the most downstream portion E1, and it is difficult to confirm the possibility that the base ink 36b drips. Since the width W1 of the most downstream portion E1 is narrower than the maximum width W2, it is possible to easily confirm the possibility that the base ink 36b drips due to the inclination of the transfer medium M1 such that the most downstream portion E1 is lower than the most upstream portion E2. Since the continuous area AR0 has a shape in which the base ink 36b easily drips, when the base ink 36b does not drip in the continuous area AR0, the ink 36 may be harder to drip during printing of other than the test pattern TP0. Further, when dripping 302 does not occur in the continuous area AR0 having the recording density of X1% which is one step lower than the recording density of X2%, the maximum ink ejection amount can be set to the recording density of X1% or more and less than the recording density of X2%.

### Specific Example of Processing of Printing Apparatus

FIG. 11 schematically illustrates processing of setting the maximum ink ejection amount. When receiving an instruction to set the maximum ink ejection amount from the host device HO1 or the operation panel 24, the control unit 10 illustrated in FIG. 4 starts maximum ink ejection amount setting processing. Here, step S104 corresponds to the printing step ST1, and step S106 corresponds to the conveying step ST2. Hereinafter, the description of "step" may be omitted, and the signs of the steps may be shown in parentheses.

When the maximum ink ejection amount setting processing is started, the control unit 10 selects the type of the test pattern TP0 to be printed on the transfer medium M1 (S102). For example, the control unit 10 performs processing of receiving a selection of printing the single-layer test pattern TP1, printing the double-layer test pattern TP2, or printing both the test patterns (TP1 and TP2) from the host device HO1 or the operation panel 24. The control unit 10 may receive the setting of the range of the recording density of the test pattern TP0 from the host device HO1 or the like, or may receive the setting of the difference in the recording density between the patches PA0 from the host device HO1 or the like.

Then, the control unit 10 performs processing of forming the selected test pattern TP0 on the transfer medium M1 (S104). When the single-layer test pattern TP1 (see FIGS. 6 and 7) is selected, the control unit 10 causes the drive unit 50 to move the print head 30 and causes the base ink head 32 to eject the base ink 36b so that the single-layer test pattern TP1 having the plurality of continuous areas AR0 in which the base ink 36b is present is printed based on the single-layer test pattern data. When the double-layer test pattern TP2 (see FIGS. 8 and 9) is selected, the control unit 10 causes the drive unit 50 to move the print head 30 and causes the print head 30 to eject the ink 36 so that the double-layer test pattern TP2 having the plurality of continuous areas AR0 in which the ink 36 including the colored ink 36a and the base ink 36b is continuous is printed based on the double-layer test pattern data.

In the above-described manner, the control unit 10 controls printing of the test pattern TP0 for determining the maximum amount of the ink 36 ejected from the print head 30 to the transfer medium M1 per unit area. As a result, the test pattern TP0 is printed.

After printing the test pattern TP0, the control unit 10 controls the conveyance unit 55 to convey the transfer medium M1 having the test pattern TP0 in the conveyance direction D1 (S106). When the conveyance unit 55 conveys the transfer medium M1 in the conveyance direction D1, as illustrated in FIG. 1, the transfer medium M1 having the test pattern TP0 reaches the descending portion 60 that is inclined downward. The user can view the test pattern TP0 present in the descending portion 60, capture an image of the test pattern TP0 with an imaging device, and transmit the captured image data to the printing apparatus 1 (including the host device HO1).

After the transfer medium M1 is conveyed, the control unit 10 sets the maximum ink ejection amount (S108), and ends the maximum ink ejection amount setting processing. For example, the control unit 10 receives the setting of the maximum ink ejection amount from the host device HO1 or the operation panel 24. In this case, the user can perform an operation of inputting or selecting the recording density at which the dripping of the ink 36 does not occur in the continuous area AR0, for example, the recording density of X1% illustrated in FIG. 10 to the host device HO1 or the operation panel 24 by viewing the test pattern TP0. The input or selected printing density, for example, the printing density of X1% is set as the maximum ink ejection amount. Further, the control unit 10 may acquire the captured image data of the test pattern TP0, determine whether the dripping of the ink 36 occurs in each continuous area AR0 based on the captured image data, and set the highest recording density in one or more continuous areas AR0 in which a determination that the dripping of the ink 36 does not occur is determined as the maximum ink ejection amount.

Thereafter, in the image printing processing (S110) of printing various images IM1, the control unit 10 performs control of printing the image IM1 so as not to exceed the set maximum ink ejection amount. As a simple example, the set maximum ink ejection amount is applied to the base ink 36b. In this case, even when the transfer medium M1 is inclined in the conveyance direction D1, the base ink 36b is ejected onto the transfer medium M1 at the maximum ink ejection amount in which the ink 36 is hard to drip, and thus the ink 36 is hard to drip.

Further, when the maximum ink ejection amount including the colored ink 36a and the base ink 36b is applied, the color conversion LUT may be constructed such that the output value of the color conversion LUT becomes a value limited to the maximum ink ejection amount. When the color conversion unit 12 converts the RGB data into the ink amount data with reference to the above-described color conversion LUT, the colored ink 36a and the base ink 36b are ejected onto the transfer medium M1 in the maximum ink ejection amount in which dripping of the ink 36 hard to occur.

As described above, when the transfer medium M1 is inclined such that the most downstream portion E1 is lower than the most upstream portion E2, the ink 36 flowing in the continuous area AR0 accumulates in the narrower most downstream portion E1, and thus easily drips from the most downstream portion E1. Accordingly, it is possible to easily confirm the possibility that the ink 36 on the transfer medium M1 drips due to the inclination described above. Since the plurality of continuous areas AR0 having different recording densities are present in the test pattern TP0, the maximum ink ejection amount can be determined in consideration of the possibility that the ink 36 on the transfer medium M1 drips.

### Modifications

Various modifications of the present disclosure are conceivable.

For example, the printer 2 may be a serial printer that performs serial printing, a line printer that performs line printing, or the like.

The medium on which the test pattern TP0 is formed is not limited to the transfer medium M1, and may be a medium that is not used for transfer, such as paper or fabric.

A portion that plays a key role to perform the processing described above is not limited to the CPU, and may be an electronic component other than the CPU, such as an ASIC (Application Specific Integrated Circuit). Obviously, a plurality of CPUs may cooperate with one another to perform the processing described above, or the CPU and another electronic component (ASIC, for example) may cooperate with each other to perform the processing described above.

Part of the print control processing illustrated in FIG. 11 may be performed by the host device HO1. In this case, the control unit of the printing apparatus 1 is a combination of the control unit 10 in a narrow sense and the host device HO1.

The combination of colors of the colored inks 36a is not limited to C, M, Y, and K, and may include orange, green, light cyan lower in density than C, light magenta lower in density than M, dark yellow higher in density than Y, and light black lower in density than K. Obviously, the configuration of the present application is also applicable to a case where the colored ink 36a does not include ink of part of the colors of C, M, Y, and K.

The ink for forming the single-layer test pattern TP1 is not limited to the base ink 36b, and may be any of the plurality of types of colored inks 36a. Here, the type of the colored ink 36a for forming the single-layer test pattern TP1 may be a type assumed to be most used in the largest amount from the viewpoint of color development of the color material or the like. For example, when the achromatic color is expressed by combining the C ink, the M ink, and the Y ink, when the C ink is used more than the M ink and more than the Y ink, the single-layer test pattern TP1 may be formed of the C ink.

The transition portion AR3 of the continuous area AR0 of the double-layer test pattern TP2 may also be formed with any of the plurality of types of colored inks 36a.

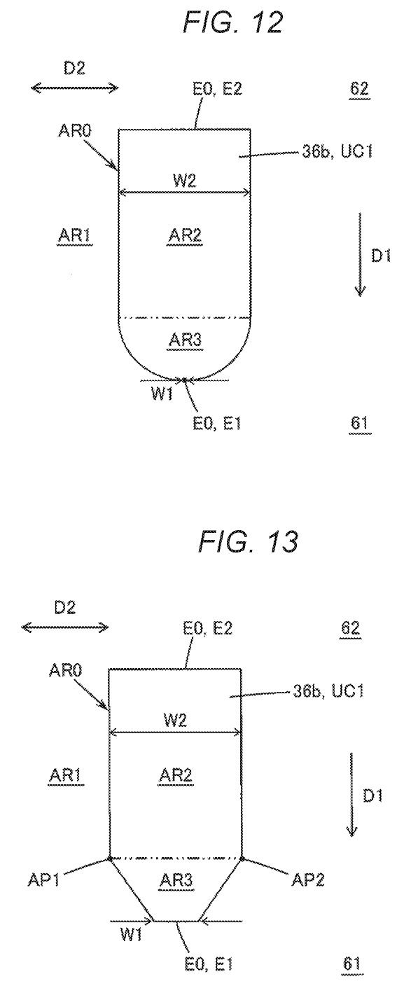

As illustrated in FIGS. 12 to 15, various shapes of the continuous area AR0 are conceivable. FIGS. 12 to 15 schematically illustrate modifications of the continuous area AR0.

As illustrated in FIG. 12, the most downstream portion E1 may not be sharp and may bulge in a curved shape. The transition portion AR3 illustrated in FIG. 12 has a semicircular shape bulging in the conveyance direction D1, and is smoothly coupled to the main body portion AR2. The diameter of the transition portion AR3 is the maximum width W2 of the continuous area AR0. Also in the transition portion AR3 shown in FIG. 12, the most downstream portion E1 can be regarded as a point and the width W1 of the most downstream portion E1 is close to zero. Therefore, when the transfer medium M1 is inclined such that the most downstream portion E1 is lower than the most upstream portion E2, the ink 36 flowing in the continuous area AR0 accumulates in the narrower most downstream portion E1, and thus easily drips from the most downstream portion E1. The transition portion AR3 may have a semi-elliptical shape, not the semicircular shape.

As illustrated in FIG. 13, the most downstream portion E1 may have a linear shape shorter than the maximum width W2. The transition portion AR3 illustrated in FIG. 12 has a trapezoidal shape tapered from the main body portion AR2 toward the most downstream portion E1, and is coupled to the main body portion AR2 at vertices AP1 and AP2. Also in the transition portion AR3 shown in FIG. 13, the width W1 of the most downstream portion E1 is narrower than the maximum width W2. Therefore, when the transfer medium M1 is inclined such that the most downstream portion E1 is lower than the most upstream portion E2, the ink 36 flowing in the continuous area AR0 accumulates in the narrower most downstream portion E1, and thus easily drips from the most downstream portion E1.

Also in the examples illustrated in FIGS. 12 and 13, it is possible to easily confirm the possibility that the ink 36 drips due to the inclination of the transfer medium M1 such that the most upstream portion E2 is lower than the most downstream portion E1.

As illustrated in FIG. 14, the width W1 of the most upstream portion E2 in the continuous area AR0 may also be narrower than the maximum width W2. The continuous area AR0 illustrated in FIG. 14 includes the downstream transition portion AR3 from the main body portion AR2 toward the most downstream portion E1 and the upstream transition portion AR3 from the main body portion AR2 toward the most upstream portion E2. The upstream transition portion AR3 including the most upstream portion E2 has an isosceles triangular shape, and the most upstream portion E2 is located at the vertex of the above-described triangular shape. Therefore, the most upstream portion E2 can be regarded as a pointed point and the width W1 of the most upstream portion E2 is close to zero. The transition portion AR3 including the most upstream portion E2 may be tapered from the main body portion AR2 toward the most downstream portion E1.

As illustrated in FIG. 15, the continuous area AR0 may include the transition portion AR3 from the main body portion AR2 toward the most upstream portion E2, and the width of the most downstream portion E1 may be the maximum width W2.

In the example illustrated in FIGS. 14 and 15, when the transfer medium M1 is inclined such that the most downstream portion E1 is higher than the most upstream portion E2, the ink 36 flowing in the continuous area AR0 accumulates in the narrower most upstream portion E2, and thus easily drips from the most upstream portion E2. Therefore, it is possible to easily confirm the possibility that the ink 36 drips due to the inclination of the transfer medium M1 such that the most upstream portion E2 is higher than the most downstream portion E1.

In the example illustrated in FIG. 14, when the transfer medium M1 is inclined such that the most downstream portion E1 is lower than the most upstream portion E2, the ink 36 flowing in the continuous area AR0 accumulates in the narrower most downstream portion E1, and thus easily drips from the most downstream portion E1. Accordingly, even when the transfer medium M1 having the test pattern TP0 is inclined in any direction in the conveyance direction D1, it is possible to easily confirm the possibility that the ink 36 drips due to the inclination. Therefore, the printing apparatus 1 capable of printing the continuous area AR0 illustrated in FIG. 14 can form the test pattern TP0 having high versatility capable of confirming the possibility that the ink 36 drips due to the inclination of the transfer medium M1 in the conveyance direction D1.

Although not illustrated, a plurality of end portions E0 whose widths can be regarded as zero may be present in the continuous area AR0. Even in this case, the width W1 of the end portion E0 is narrower than the maximum width W2, and the ink 36 flowing in the continuous area AR0 easily drips from the end portion E0 because the ink accumulates in the narrower end portion E0. Therefore, it is possible to easily confirm the possibility that the ink 36 drips due to the inclination of the medium in the conveyance direction D1.

### Conclusions:

As described above, in the present disclosure, according to various configurations, it is possible to provide a configuration and the like capable of easily confirming the possibility that the ink on the medium drips when confirming the maximum amount of the ink ejected from the print head to the medium per unit area. Obviously, the basic functions and effects described above can also be achieved by configurations having only configuration requirements according to the independent claims.

Further, it is possible to implement a configuration in which the elements disclosed in the examples described above are replaced with one another or the combinations thereof are changed, a configuration in which the elements disclosed in known technologies and the examples described above are replaced with one another or the combinations thereof are changed, and the like. The present disclosure also includes these configurations described above and the like.

What is claimed is:

1. A printing apparatus comprising:
a conveyance unit that conveys a medium in a conveyance direction;
a print head configured to eject an ink onto the medium; and
a control unit that controls printing of a test pattern for determining a maximum amount of the ink to be ejected from the print head to the medium per unit area, wherein
the test pattern has a continuous area in which the ink is continuous at a set recording density, around which the ink is not ejected,
with a length in a width direction intersecting the conveyance direction as a width, a width of an end portion of the continuous area, which is most downstream or most upstream in the conveyance direction, is narrower than a maximum width of the continuous area, and
the control unit performs control on at least the print head to print the test pattern having the continuous area.

2. The printing apparatus according to claim 1, wherein
the continuous area includes a main body portion having a width equal to the maximum width of the continuous area and a transition portion from the main body portion toward the end portion, and
the transition portion has a shape tapered from the main body portion toward the end portion.

3. The printing apparatus according to claim 2, wherein
the transition portion including the end portion has a triangular shape, and the end portion is located at a vertex of the triangular shape.

4. The printing apparatus according to claim 1, wherein
the print head is configured to eject, as the ink, an image forming ink for forming an image and a base ink for forming a base ink layer onto the medium, and
the control unit performs control on at least the print head to print the continuous area where at least the base ink is present.

5. The printing apparatus according to claim 4, wherein
both the image forming ink and the base ink are present in the continuous area, and
the control unit performs control on at least the print head to print the continuous area where the ink including the image forming ink and the base ink is continuous.

6. The printing apparatus according to claim 1, wherein
the test pattern includes a plurality of the continuous areas having different recording densities, and
the control unit performs control on at least the print head to print the test pattern including the plurality of continuous areas.

7. A test pattern printing method, in a printing apparatus including a conveyance unit that conveys a medium in a conveyance direction and a print head configured to eject an ink onto the medium, of printing a test pattern for determining a maximum amount of the ink to be ejected from the print head to the medium per unit area,
the test pattern having a continuous area in which the ink is continuous at a set recording density, around which the ink is not ejected,
with a length in a width direction intersecting the conveyance direction as a width, a width of an end portion of the continuous area, which is most downstream or most upstream in the conveyance direction, being narrower than a maximum width of the continuous area,
the test pattern printing method comprising:
a printing step of printing the test pattern having the continuous area by ejecting the ink on medium from the print head; and
a conveying step of conveying the medium having the test pattern in the conveyance direction by the conveyance unit.
